(19) United States
(12) Patent Application Publication
(10) Pub. No.: US 2018/0184174 A1
(43) Pub. Date: Jun. 28, 2018

(54) BROADCAST RECEIVER AND CONTROLLING METHOD THEREOF

(71) Applicant: SAMSUNG ELECTRONICS CO., LTD., Suwon-si (KR)

(72) Inventor: Shin-gwan KANG, Suwon-si (KR)

(21) Appl. No.: 15/651,019

(22) Filed: Jul. 17, 2017

(30) Foreign Application Priority Data
Dec. 28, 2016 (KR) 10-2016-0181207

(51) Int. Cl. H04N 21/61; H04N 21/438; H04N 21/63; H04N 5/44; H04N 5/445

(52) U.S. Cl. CPC H04N 21/6118; H04N 21/4383; H04N 5/44513; H04N 5/4401; H04N 5/4403; H04N 21/63

(57) ABSTRACT

A broadcast receiver is disclosed. The broadcast receiver includes a cable modem including a controller configured to operate using modem software, the cable modem configured to receive an image signal from an external apparatus, a communicator comprising communication circuitry configured to transmit the received image signal to a display apparatus and a processor configured to control the communicator to transmit the image signal to the display apparatus in response to receiving the image signal, to transmit verification information generated based on a pre-stored first table to the cable modem and to determine whether the modem software is genuine based on a code value received from the cable modem and the first table.

### CROSS-REFERENCE TO RELATED APPLICATION

This application is based on and claims priority under 35 U.S.C. § 119 to Korean Patent Application No. 10-2016-0181207, filed in the Korean Intellectual Property Office on Dec. 28, 2016, the disclosure of which is incorporated by reference herein in its entirety.

### BACKGROUND

### 1. Field

The present disclosure relates generally to a broadcast receiver and a controlling method thereof, and for example, to a broadcast receiver which performs verification of a cable modem software pre-stored in a cable modem and a controlling method thereof.

### 2. Description of Related Art

Generally, a broadcast receiver is a device which receives a broadcast signal. A broadcast receiver converts a digital broadcast or an analog broadcast transmitted from a broadcasting station and an image signal and a voice signal input from various external apparatuses (a video player, a DVD player, etc.) into a TS signal, and displays the TS signal on an external display apparatus. A set-top box is one example of a broadcast receiver.

In such a broadcast receiver, a cable modem for high-speed data communication may be provided. A broadcast receiver with a cable modem not only displays an image signal received through a cable network but also enables bilateral high-speed data communication with a service provider by a cable modem.

In the cable modem of a broadcast receiver, software for operating a cable modem and control of operations is provided, and the cable modem needs software upgrade to change use environment and improve performance. Once a broadcast receiver downloads a cable modem software, verification is performed to the entire software. If no problem is found, the existing software of the cable modem is upgraded with the downloaded software.

There is no problem in the process of downloading and updating new software as the process goes through a verification process. However, if the cable modem already has the software that is changed by a hacker, there is no way to verify the software.

### SUMMARY

An aspect of example embodiments of the present disclosure relates to a broadcast receiver which performs verification of cable modem software pre-stored in a cable modem and a controlling method thereof

According to an example embodiment, the broadcast receiver may include a cable modem including a controller configured to operate using modem software, the cable modem configured to receive an image signal from an external apparatus, a communicator comprising communication circuitry configured to transmit the received image signal to a display apparatus and a processor configured to control the communicator to transmit the image signal to the display apparatus in response to reception of the image signal, to transmit verification information generated based on a pre-stored first table to the cable modem and to determine whether the modem software is genuine based on a code value received from the cable modem and the first table.

The processor may periodically update the first table.

The first table may include a plurality of code values corresponding to each of a plurality of key values, and the processor may transmit verification information generated based on a random key value among the plurality of key values to the cable modem, and in response to reception of a code value corresponding to the random key value from the cable modem, determine that the modem software is genuine.

The cable modem may include a memory in which the modem software is provided, and the memory may store a second table corresponding to the first table in response to determining that the modem software is genuine.

The cable modem may transmit a code value corresponding to the random key value to the processor based on the second table in response to reception of the verification information from the processor.

The processor may update the first table, and update the second table to correspond to the update of the first table.

The processor may process the random key value and generate the verification information based on a different value from the random key value.

The processor may transmit information on a method for processing the random key value to the cable modem together with the generated verification information.

The processor may transmit the verification information to the cable modem by one interface method of: a universal serial bus (USB), Ethernet and a programmable communication interface (PCI).

A method for controlling a broadcast receiver is also provided, the method includes receiving an image signal from an external device, transmitting the received image signal to a display apparatus, transmitting verification information generated based on a pre-stored first table to the cable modem and determining whether the modem software is genuine based on a code value received from the cable modem and the first table.

The method may further include updating the first table periodically.

The first table may include a plurality of code values corresponding to each of a plurality of key values, the transmitting may include transmitting verification information corresponding to a random key value among the plurality of key values to the cable modem, and the determining may include determining that the modem software is genuine in response to reception of a code value corresponding to the random key value from the cable modem.

The cable modem may store a second table corresponding to the first table in response to determining that the modem software is genuine.

The method may further include transmitting a code value corresponding to the random key value to the processor based on the second table in response to reception of the verification information from the processor.

The method may further update the first table, and update the second table to correspond to the update of the first table.

The transmitting may include processing the random key value and generating the verification information based on a different value from the random key value, and transmitting the generated verification information to the cable modem.

The transmitting may include transmitting information on a method for processing the random key value to the cable modem together with the verification information.

The transmitting may include transmitting the verification information to the cable modem by one interface method of: a universal serial bus (USB), Ethernet and a programmable communication interface (PCI).

### BRIEF DESCRIPTION OF THE DRAWINGS

The above and other aspects, features and attendant advantages of the present disclosure will be apparent and more readily appreciated from the following detailed description, taken in conjunction with the accompanying drawings, in which like reference numerals refer to like elements, and wherein:

FIG. 1 is a diagram illustrating an example cable broadcasting system according to an example embodiment;

FIG. 2 is a block diagram illustrating an example broadcast receiver according to an example embodiment;

FIG. 3 is a diagram illustrating an example embodiment of a cable modem and a processor which are included in a broadcast receiver; and

FIG. 4 is a flowchart illustrating an example method for controlling a broadcast receiver according to an example embodiment.

### DETAILED DESCRIPTION

In describing the present disclosure, when a detailed description for the known functions or configurations related to the present disclosure may unnecessarily obscure the gist of the present disclosure, the detailed description therefor may be omitted. The terms described below are defined in consideration of a function in an example embodiment, and the definition may vary depending on users, operators, precedents, etc. Therefore, the terms used in the example embodiments should be defined based on the contents of this disclosure in a comprehensive manner.

The terms “first”, “second”, etc. may be used to describe diverse components, but the components are not limited by the terms. The terms are only used to distinguish one component from the others.

The terms used in the description are to explain example embodiments, and not to constrict and/or limit the present disclosure. A singular term includes a plural form unless otherwise indicated. The terms “include,” “comprise,” “is configured to,” etc. in the description are used to indicate the presence of features, numbers, steps, operations, elements, parts or combination thereof, and do not exclude the possibilities of combination or addition of one or more features, numbers, steps, operations, elements, parts or combination thereof.

In an example embodiment, ‘a module’ or ‘a unit’ performs at least one function or operation, and may be realized as hardware, software, or combination thereof. Further, except the “modules” or “units” that have to be implemented as certain hardware, a plurality of “modules” or a plurality of “units” may be integrated into at least one module and realized as at least one processor.

Hereinafter, the example embodiments of the present disclosure will be described in greater detail with reference to the accompanying drawings. However, the example embodiments may be implemented as various different forms, and the disclosure is not limited to the example embodiments described herein. In the drawings, parts that are not relevant to the description may be omitted to clearly describe the embodiments, and like drawing reference numerals are used for the like elements throughout the specification.

Hereinafter, the present disclosure will be described in greater detail with reference to the accompanying drawings.

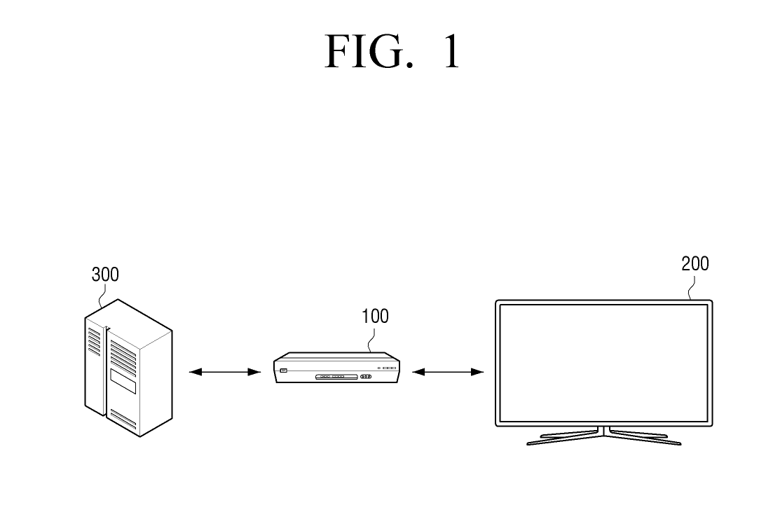

FIG. 1 is a diagram illustrating an example cable broadcasting system according to an example embodiment.

Referring to FIG.1, a cable broadcasting system may include a server 300, a broadcast receiver 100 and a display apparatus 200.

The server 300 may, for example, and without limitation, be a server of a service provider (SP). The server 300 may be provided with a content from a content provider (CP) that manufactures and provides various contents. The content provider may be a terrestrial broadcaster, a cable system operator or a multiple system operator, a satellite broadcaster, an Internet broadcaster and the like.

The server 300 may package contents provided by such content providers into a service package and provide the service package. For example, the server 300 may package a first terrestrial broadcast, a second terrestrial broadcast, a cable MSO, a satellite broadcast, various Internet broadcasts and provide the package to the broadcast receiver 100.

The server 300 may be connected with the broadcast receiver 100 by a hybrid fiber coax (HFC).

The broadcast receiver 100 may, for example, and without limitation, be a set-top box with an embedded cable modem. The broadcast receiver 100 may receive an image signal transmitted from the server 300 through a cable modem and output the received image signal to the display apparatus 200.

The broadcast receiver 100 may download cable modem software from a server 300 and update cable modem software. The broadcast receiver 100 may perform a verification to the downloaded cable modem software, and proceed with an update if no problem is found. Further, the broadcast receiver 100 may also perform a verification to the software already provided in the cable modem. Therefore, the broadcast receiver 100 may verify any change in cable modem software caused by a cracker.

Meanwhile, FIG. 1 illustrates the broadcast receiver 100 and the display apparatus 200 as separate apparatuses, but the broadcast receiver 100 and the display apparatus 200 may be implemented in one apparatus. For example, and without limitation, the example embodiment illustrated in the present disclosure may be implemented by a digital cable ready (DCR) including an embedded set-top box and an embedded cable modem. The DCR TV may refer to a TV that a user can view a digital cable broadcast by simply inserting a cable card into a TV and connecting a cable without any separate set-top box.

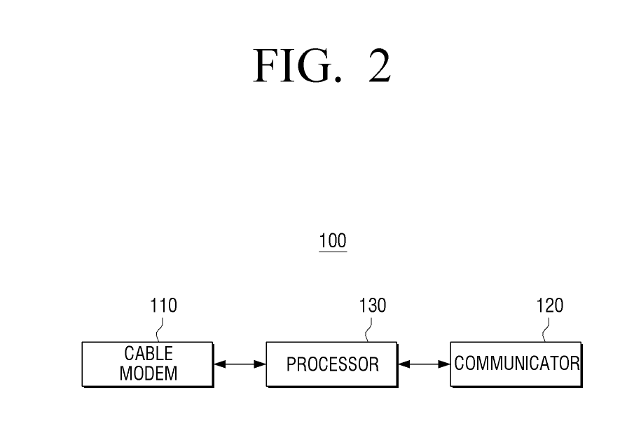

FIG. 2 is a block diagram illustrating an example broadcast receiver 100 according to an example embodiment.

The broadcast receiver 100 may, for example, and without limitation, be an open-cable set-top box. The broadcast receiver 100 may include a cable modem 110, a communicator (e.g., including communication circuitry) 120 and a processor (e.g., including processing circuitry) 130.

The cable modem 110 may be connected with an external apparatus through a cable network and transmit various signals and data to, and receive various signals and data from, the external apparatus. The cable modem 110 may be a cable modem based on data over cable service interface specifications (DOCSIS).

The cable modem 110 may include a controller operating using modem software.

The cable modem 110 may receive an image signal through at least one tuner, and demodulate the received image signal and provide the demodulated image signal to the processor 130. The processor 130 may include various processing circuitry and perform various image-processes to the image signal provided through the cable modem 130 and transmit the processed image signal to the display apparatus 200.

The processor 130 may be configured to control overall operations of the broadcast receiver 100. The processor 130 may include, for example, and without limitation, a CPU, a RAM, a ROM and a system bus.

The processor 130 may control the communicator 120 to transmit an image signal received through the cable modem 110 to the display apparatus 200.

The communicator 120 may communicate with various external apparatuses. For example, the communicator 120 may communicate with the display apparatus 200. For example, the communicator 120 may include a component output terminal, and also include a high definition multimedia interface (HDMI) port.

The communicator 120 may also include various communication circuitry and/or communication chips such as, for example, and without limitation, a Wi-Fi chip, a Bluetooth chip, an NFC chip, a wireless communication chip or the like.

The processor 130 may verify whether modem software separately provided in the cable modem 110 is normal.

To this end, a first table including a plurality of key values and a plurality of code values corresponding to each of the plurality of key values may be stored in a memory of the processor 130. If the modem software provided in the cable modem 110 is genuine, a second table corresponding to the first table may be stored in a memory of the cable modem 110. The second table may be the same as the first table.

The processor 130 and the cable modem 110 may perform software genuineness verification process based on the first table and the second table.

For example, the processor 130 may transmit verification information generated based on the pre-stored first table to the cable modem 110, and determine whether modem software provided in the cable modem is genuine by identifying whether a code value corresponding to the transmitted verification information is received from the cable modem 110.

The verification information may be generated based on a random key value among the plurality of key values of the first table. According to an example embodiment, the verification information may be a random key value among the plurality of key values. The processor 130 may select one of key values randomly from among the plurality of key values and use the key value as verification information whenever a software verification is necessary.

Meanwhile, if a key value is used as verification information, there may be a problem that the key value might be exposed to outside. Therefore, according to another example embodiment, verification information may be generated based on a different value from the random key value that is generated by processing the random key value among the plurality of key values. The processor 130 may generate verification information by processing a key value in various ways.

For example, the processor 130 may randomly select one key value from among the plurality of key values of the first table, and divide the selected key value and generate a plurality of pieces of divided data. Then, the processor 130 may insert a random value between the plurality of pieces of divided data and generate verification information. The verification information generated as above may prevent the position where the pieces of valid key value are disposed from being exposed to outside. That is, even if the randomly selected key value is the same, the value that is actually transmitted to the cable modem 110 is always different, and thereby security may be improved.

If verification information is generated by processing a key value as above, the processor 130 may transmit verification information to the cable modem 110 together with information on the method for processing a key value. If a key value is processed by dividing the key value into a plurality of pieces of divided data and inserting a random value between the pieces of divided data according to the example embodiment, the information on the method for processing the key value may include information on the position where the plurality of pieces of divided data are present, which is valid information, and information on the position where a random value is inserted, which is meaningless information inserted between the plurality of pieces of divided data.

Once verification information is received from the processor 130, the cable modem 110 in which genuine software is provided may transmit a code value corresponding to the received verification information to the processor 130 based on a pre-stored second table.

That is, the cable modem 110 may obtain a key value from verification information and transmit a code value corresponding to the obtained key value to the processor 130.

If verification information is transmitted from the processor 130 together with the information on the method for processing a key value, the cable modem 110 may interpret the verification information based on the information on the method for processing the key value and obtain the key value. As in the example embodiment described above, if verification information is generated based on a plurality of pieces of divided data and by inserting a random value between the plurality of pieces of divided data, the controller of the cable modem 110 may identify the position where the plurality of pieces of divided data are inserted, obtain the plurality of pieces of divided data and recover the original key value based on the information on the method for processing the key value.

The controller of the cable modem 110 may identify a code value corresponding to the key value obtained from verification information in the pre-stored second table and transmit the identified code value to the processor 130.

The controller of the cable modem 110 may transmit the code value to the processor 130 as it is, or process the code value by the similar method as the aforementioned method for processing a key value and transmit the processed code value to the processor 130.

For example, the controller of the cable modem 110 may identify a code value corresponding to the key value obtained from verification information based on the second table, and divide the identified code value and generate a plurality of pieces of divided data. Then, the controller of the cable modem 110 may insert a random value between the plurality of pieces of divided data and generate a processed code value, and transmit the code value to the processor 130. When transmitting the code value, the controller of the cable modem 110 may also transmit information on the method for processing the code value to the processor 130 together with the code value.

The processor 130 may determine that modem software provided in the cable modem 110 is genuine if the code value received from the cable modem 110 corresponds to the verification information transmitted previously. If the code value does not correspond to the verification information, the processor 130 may determine that modem software is not genuine.

That is, the processor 130 may identify a key value corresponding to the code value received from the cable modem 110 based on the first table, and if the identified key value has been used in generating the verification information transmitted beforehand, the processor 130 may determine that the modem software provided in the cable modem 110 is genuine.

If the processed code value and the information on the method for processing the code value are received from the cable modem 110, the processor 130 may recover the processed code value to the original code value based on the information on the processing method. The processor 130 may identify a key value corresponding to the recovered code value based on the first table, and if the identified key value has been used in generating the verification information transmitted beforehand, the processor 130 may determine that the modem software provided in the cable modem 110 is genuine.

Meanwhile, if the cable modem 110 does not respond to transmission of verification information, or if a code value which does not correspond to verification information is received, the processor 130 may determine that the modem software provided in the cable modem 110 is not genuine.

If it is determined that the modem software is not genuine, the processor 130 may cease the transmission of an image signal received in the cable modem 110 to the display apparatus 200. Further, the processor 130 may notify to the server of a service provider that non-genuine software is used, and the service provider may take appropriate measures accordingly.

If it is determined that the modem software of the cable modem 110 is not genuine, the processor may download genuine software from the server 300, and control the cable modem 110 to upgrade the software with the downloaded software.

For example, the processor 130 may download modem software in the memory provided in the processor 130 and control to upgrade the existing software of the cable modem 110 with the downloaded software.

Further, the processor 130 may transmit a software upgrade command to the cable modem 110 using a trivial file transfer protocol (TFTP). Before transmitting the software upgrade command, the processor 130 may transfer an IP address of the processor 130 and the file name of software stored in the processor 130 to the cable modem 110.

The cable modem 110 that has received the software upgrade command may access to the processor 130 using the received IP address of the processor 130. Then, the cable modem 110 may download software corresponding to the file name of the received software in a memory provided in the cable modem 110. The cable modem 110 may download software from the processor 130 using a TFTP.

The broadcast receiver 100 may be implemented, for example, and without limitation, by a set-top box in which the cable modem 110 is provided. In order to provide a bilateral service, the set-top box configured to use a cable modem has a host which is a subject of a bilateral service. The processor 130 may correspond to the host, and a CPU present in the processor 130 may be referred to as a main CPU. Also, a modem software may be provided in the cable modem 110, and the cable modem 110 may operate independently from the processor 130. In other words, the processor 130 and the cable modem 110 may have a dual processing structure. In this case, the cable modem 100 may include an exclusive controller which is exclusively used for a cable modem.

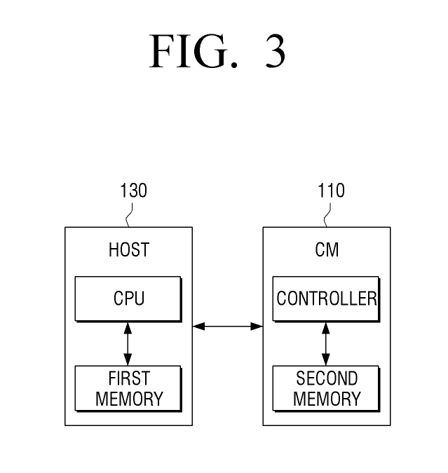

FIG. 3 is a diagram illustrating an example of the processor 130 and the cable modem 110 provided in the broadcast receiver 100 according to an example embodiment.

The processor 130 may include various processing circuitry, such as, for example, and without limitation, a CPU, and a first memory. The cable modem 110 (CM) may include a controller (e.g., including processing circuitry) and a second memory. The controller of the cable modem 110 may control overall functions of the cable modem 110.

The processor 130 and the cable modem 110 may have a dual processing structure, and may use one of a universal serial bus (USB), a USB 2.0, Ethernet and a programmable communication interface (PCI) as an interface method.

The processor 130 may transmit verification information to the modem cable 110 by the above interface methods, and if a genuine modem software is provided, the cable modem 110 may transmit a code value corresponding to the received verification information to the processor 130 by the above interface methods.

The first table may be stored in the first memory of the processor 130. In the second memory of the cable modem 110, modem software is provided, and if the modem software is genuine, the second table that is the same as the first table stored in the first memory may be stored in the second memory.

The processor 130 may periodically update the tables stored in the first memory and the second memory. Each table may be modified by image update. The image herein may refer, for example, to software which can operate various types of semiconductor devices such as a computing system, a mobile device, security hardware, a device controller, etc. or “software image” including data in relation to an operating system.

If the table is periodically modified as described above, it may not be easy to counterfeit or falsify modem software.

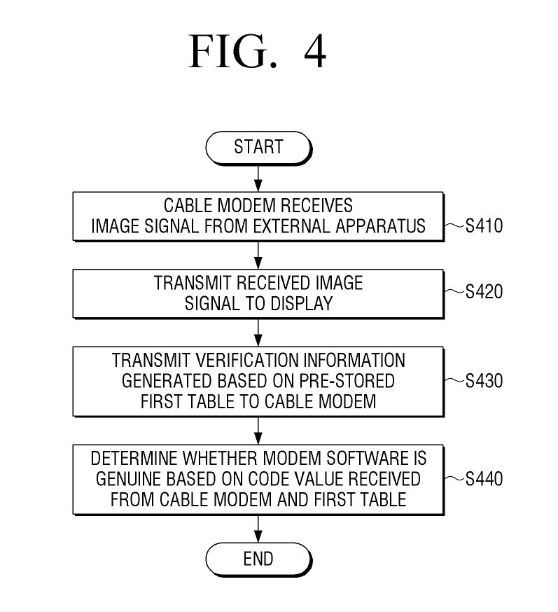

FIG. 4 is a flowchart illustrating an example method for controlling a broadcast receiver according to an example embodiment.

Referring to FIG. 4, a cable modem of a broadcast receiver which includes a controller operating using modem software may receive an image signal from an external apparatus (S410).

The processor of the broadcast receiver may transmit the received image signal to a display apparatus (S420).

The processor may transmit verification information generated based on a pre-stored first table to the cable modem (S430).

The first table may include a plurality of code values corresponding to each of a plurality of key values. For example, the plurality of key values of the first table may be composed of natural numbers, and the plurality of code values may be composed of a plurality of random numbers (consecutive random numbers having no certain arrangement order or rule) corresponding to each of the plurality of key values which are natural numbers.

The cable modem may store a second table corresponding to the first table if modem software is genuine.

In operation S430, the processor may transmit verification information corresponding to a random key value among the plurality of key values to the cable modem.

In operation S430, the processor may process the random key value and generate the verification information based on a different value from the random key value, and transmit the generated verification information to the cable modem. For example, the processor may divide the random key value into a plurality of pieces of divided data and insert a random value between the plurality of pieces of divided data, thereby making a different value from an original key value and generating verification information based on the value.

Further, the processor may transmit information on the method for processing a key value described above to the cable modem together with the verification information.

Once the verification information is received from the processor, the cable modem may transmit a code value corresponding to the random key value to the processor based on the second table.

The processor may determine whether the modem software is genuine based on the code value received from the cable modem and the pre-stored first table (S440).

If the verification information corresponding to the random key value is transmitted to the cable modem, the processor may determine that the modem software is genuine once a code value corresponding to the random key value is received from the cable modem in operation S420.

The controlling method may further include the process of periodically updating the first table by the processor. The processor may also periodically update the second table to correspond to the first table.

The processor may periodically update the first table and the second table by itself or according to an external cause such as an update command from a server 300. For example, if the first table and the second table are composed of a plurality of key values which are natural numbers and a plurality of random numbers corresponding to the plurality of key values, the table may be updated by modifying the plurality of random numbers to other random numbers.

According to the various example embodiments described above, it may be possible to verify even the modem software that is already stored in a cable modem as the software could have been modified by someone. Therefore, the damage caused by hacking of cable modem software may be prevented.

Various example embodiments described above may be embodied in a recording medium that may be read by a computer or a similar apparatus to the computer by using software, hardware, or a combination thereof. According to the hardware embodiment, the example embodiments that are described in the present disclosure may be embodied by using at least one selected from a dedicate processor, a CPU, Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, electrical units for performing other functions. In some cases, example embodiments that are described in the present specification may be embodied as the processor 130. According to the software embodiment, embodiments such as processes and functions described in the present specification may be embodied as additional software modules. Each of the software modules may perform one or more functions and operations described in the specification.

The aforementioned method for controlling a broadcast receiver according to various example embodiments may be implemented by at least one program to perform the method, and the program may be stored in a non-transitory readable medium. The non-transitory readable medium may be mounted on various apparatuses.

A non-transitory readable medium is a medium which stores data, and may perform a reading through a device. For example, the programs for performing the various methods described above may be stored in and provided through a non-temporary reading device such as a CD, a DVD, a hard disk, Blu-Ray, a disk, an USB, a memory card, a ROM and the like.

For example, a recording medium in which a program for performing the method for controlling a broadcast receiver which includes the operation in which a processor of the broadcast receiver transmits verification information generated based on a pre-stored first table to a cable modem of a broadcast receiver and the operation in which the processor determines whether the modem software is genuine based on a code value received from the cable modem and the first table, may be provided.

Also, a recording medium in which a program for performing the method for controlling a broadcast receiver which includes the operation in which the cable modem of the broadcast receiver receives verification information from the processor of the broadcast receiver and the operation in which the cable modem transmits a code value corresponding to the received verification information to the processor based on the pre-stored table, may be provided.

Further, a recording medium in which a program for performing the method for controlling the broadcast receiver which includes the operation in which the processor of the broadcast receiver transmits verification information generated based on the pre-store first table to the cable modem of the broadcast receiver, the operation in which the cable modem of the broadcast receiver transmits a code value corresponding to the receive verification information to the processor based on a pre-stored second table corresponding to the first table and the operation in which the processor determines whether the modem software is genuine based on the code value received from the cable modem and the first table, may be provided.

The foregoing example embodiments and advantages are merely examples and are not to be construed as limiting the example embodiments. The description of the example embodiments is intended to be illustrative, and not to limit the scope of the disclosure, as defined by the appended claims, and many alternatives, modifications, and variations will be apparent to those skilled in the art.

What is claimed is:

1. A broadcast receiver comprising:
a cable modem comprising a controller configured to operate using modem software, the cable modem configured to receive an image signal from an external apparatus;
a communicator comprising communication circuitry configured to transmit the received image signal to a display apparatus; and
a processor configured to control the communicator to transmit the image signal to the display apparatus in response to receiving the image signal, to transmit verification information generated based on a pre-stored first table to the cable modem and to determine whether the modem software is genuine based on a code value received from the cable modem and the first table.

2. The broadcast receiver of claim 1, wherein the processor is configured to periodically update the first table.

3. The broadcast receiver of claim 1, wherein the first table comprises a plurality of code values corresponding to each of a plurality of key values, and
wherein the processor is configured to transmit verification information generated based on a random key value among the plurality of key values to the cable modem, and to determine that the modem software is genuine in response to receiving a code value corresponding to the random key value from the cable modem.

4. The broadcast receiver of claim 3, wherein the cable modem comprises a memory in which the modem software is stored, and
wherein the memory is configured to store a second table corresponding to the first table in response to the modem software being genuine.

5. The broadcast receiver of claim 4, wherein the cable modem is configured to transmit a code value corresponding to the random key value to the processor based on the second table in response to receiving the verification information from the processor.

6. The broadcast receiver of claim 4, wherein the processor is configured to update the first table, and to update the second table to correspond to the update of the first table.

7. The broadcast receiver of claim 3, wherein the processor is configured to process the random key value and to generate the verification information based on a different value from the random key value.

8. The broadcast receiver of claim 7, wherein the processor is configured to transmit information on a method for processing the random key value to the cable modem together with the generated verification information.

9. The broadcast receiver of claim 1, wherein the processor is configured to transmit the verification information to the cable modem using one or more interface methods of: a universal serial bus (USB), Ethernet and a programmable communication interface (PCI).

10. A method for controlling a broadcast receiver, the method comprising:
receiving an image signal from an external device;
transmitting the received image signal to a display apparatus;
transmitting verification information generated based on a pre-stored first table to the cable modem; and
determining whether the modem software is genuine based on a code value received from the cable modem and the first table.

11. The method of claim 10, further comprising:
updating the first table periodically.

12. The method of claim 10,
wherein the first table comprises a plurality of code values corresponding to each of a plurality of key values,
wherein the transmitting comprises transmitting verification information corresponding to a random key value among the plurality of key values to the cable modem, and
wherein the determining comprises determining that the modem software is genuine in response to receiving a code value corresponding to the random key value from the cable modem.

13. The method of claim 12, wherein the cable modem stores a second table corresponding to the first table in response to the modem software being genuine.

14. The method of claim 13, further comprising:
transmitting a code value corresponding to the random key value to the processor based on the second table in response to receiving of the verification information from the processor.

15. The method of claim 13, further comprising:
updating the first table, and updating the second table to correspond to the update of the first table.

16. The method of claim 12, wherein the transmitting comprises processing the random key value and generating the verification information based on a different value from the random key value, and transmitting the generated verification information to the cable modem.

17. The method of claim 16, wherein the transmitting comprises transmitting information on a method for processing the random key value to the cable modem together with the verification information.

18. The method of claim 10, wherein the transmitting comprises transmitting the verification information to the cable modem using one or more interface methods of: a universal serial bus (USB), Ethernet and a programmable communication interface (PCI).
